(19) United States
(12) Patent Application Publication
(10) Pub. No.: US 2025/0298910 A1
(43) Pub. Date: Sep. 25, 2025

(54) PROTECTION OF AI MODELS

(71) Applicant: Infineon Technologies AG, Neubiberg (DE)

(72) Inventors: Walther Pachler, Graz (AT); Mathias Gangl, Graz (AT); Dominic Peter Pirker, Graz (AT); Mihai Adrian Tudosie, Trofaiach (AT)

(21) Appl. No.: 19/089,118

(22) Filed: Mar. 25, 2025

(30) Foreign Application Priority Data
Mar. 25, 2024 (DE) 10 2024 202 812.6

(51) Int. Cl. G06F 21/60; G06F 21/74; H04L 9/06

(52) U.S. Cl. CPC G06F 21/602; G06F 21/74; H04L 9/0631

(57) ABSTRACT

An edge device is proposed that comprises a first memory configured to receive and store an artificial intelligence model (AI model) and a pre-processor configured to pre-process sensor data. The edge device further comprises a protected memory for storing modifying data, and a classification stage for running the AI model on the pre-processed data that is modified based on the modifying data. The classification stage outputs output data generated by running the AI model on the modified pre-processed data.

The present disclosure relates to the use of models of artificial intelligence (AI) on edge devices.

### REFERENCE TO RELATED APPLICATION

This application claims priority to German Application number 10 2024 202 812.6, filed on Mar. 25, 2024, the contents of which are hereby incorporated by reference in their entirety.

### BACKGROUND

Artificial (AI) training in the cloud is a process that includes training machine learning models on cloud computing resources. The cloud provides a scalable and cost-effective way to train models by providing access to large amounts of computing power and storage.

AI Platform Training by Google Cloud is one of such platforms that run a training job on computing resources in the cloud. With Google Cloud, a built-in algorithm may be trained on a dataset without writing a training application. Vertex AI Training is another platform that allows submission of a training job that depends on specific requirements and preferences.

Since computational power is largely available, AI is gaining more and more momentum. It is easy to collect a large amount of data with a wearable such as a smartphone. This dataset can be used to train an AI model via one of the mentioned online services.

“Training DNN Model with secret Key for Model Protection” by April Pyone, Maung Maung and Hiotshi Kiya, IEEE 9^{th} Global Conference on Consumer Electronics, 2020, discloses that a block-wise pixel shuffling with a secret key as a preprocessing technique to input images may be used for AI model protection.

The AI models can be stripped down to a very small and efficient library (pre-trained AI model) for edge devices. An edge device is an endpoint on a network, an interface between the data center and the real world. Edge devices collect or communicate information. They run the gamut from simple sensors to complex industrial systems. They may be scanners and smartphones, medical devices and scientific instruments, autonomous vehicles and automated machines. Thus, the model size and footprint are typically in the range of a few kB and optimized to run on common architectures such as a cortex MO.

The state-of-the-art machine-learning (ML) generated pre-trained AI models are used directly on edge devices. It is an object of this disclosure to protect AI models from manipulation and/or counterfeit.

### SUMMARY

In embodiments, an edge device is disclosed that comprises a first memory configured to receive and store an artificial intelligence model (AI model). A pre-processor is configured to pre-process sensor data and a protected memory is configured for storing modifying data. A calculation stage is configured for modifying the pre-processed data based on the modifying data and for outputting encrypted, modified data. A computing unit is configured for running the AI model on the encrypted, modified data and for outputting output data generated by running the AI model on the encrypted, modified data.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated embodiments can be combined unless they exclude each other.

FIG. 1 illustrates an apparatus that trains an edge device.

FIG. 2 discloses a first embodiment of a training apparatus with a protected AI model.

FIG. 3 shows how sensor data is pre-processed.

FIG. 4 discloses a second embodiment of a training apparatus with a protected AI model.

FIG. 5 discloses a third embodiment of a training apparatus with a protected AI model.

### DETAILED DESCRIPTION

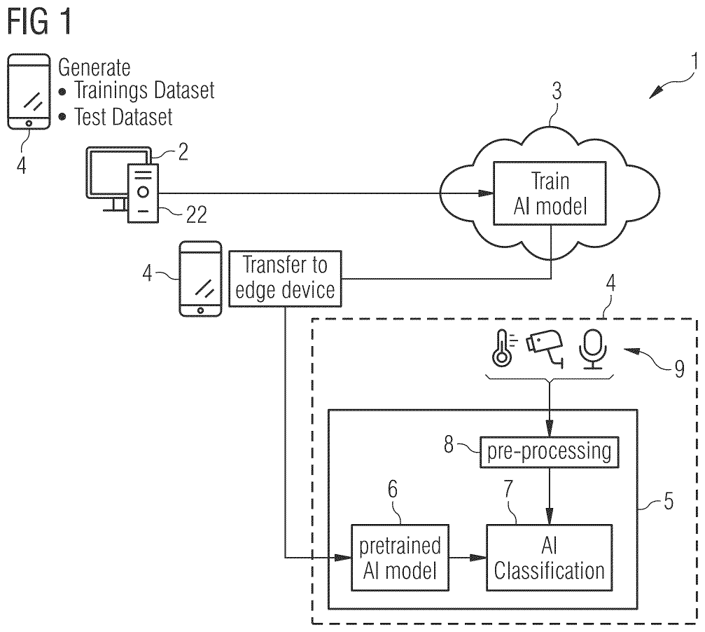

FIG. 1 shows an apparatus 1 for training an edge device 4. The edge device 4 may be a mobile device like a mobile phone or a camera or a thermometer. The apparatus comprises a workstation 2 that is connected to the cloud 3 containing hardware resources to calculate training data. The workstation 2 is used to collect a training dataset 22, which may be collected by a couple of edge devices 4 with their respective sensors. The training dataset 22 may be used to generate an AI model that classifies specific patterns in the datafile to classes. E.g. the training data set may contain audio data and patterns with a certain characteristic. The patterns may be classified as alternatively human voice, as dog barking or machine noise with the help of a neural network employing artificial intelligence. Another classification may distinguish between audio signals representing different spoken words.

The training algorithm in the cloud 3 may also comprise data characterizing the hardware of the edge device 4 that shall eventually perform the classification in the field. Accordingly, the parameters of the AI model may differ in dependence of the hardware configuration of the edge devices 4. An edge device 4 with more computing power may use an algorithm that uses more instructions per time, hence resulting in a more accurate computing result compared to an edge device with less hardware resources.

After the generation of an AI model, based on the training data and the hardware characteristics, the parameters of the AI model will be transferred to the edge device 4, which may contain a memory 6 in a microcontroller 5 for the pre-trained AI model. On the other hand, the microcontroller 5 may receive data from sensors 9 like a temperature sensor, a camera or a microphone. This data is fed to a pre-processor 8 of the microcontroller 5, which pre-processes the sensor data and forwards the pre-processed data to an AI classification stage 7. The classification stage 7 additionally receives input from the memory 6. The pre-processing may contain analog-to-digital conversion and/or Fourier transform and/or filtering and/or error correction.

The classification stage 7 classifies the received sensor data according to the pre-trained AI model in the memory 6. The result of the classification stage 7 is provided as output data. The output data of the classification stage 7 may be used for an actuator of the edge device 4 or may be displayed to a user on a screen or may be forwarded to an instance external to the edge device 4. The example of FIG. 1 does not show any protection for the AI model. AI models may embody valuable trade secrets which the creator of the trade secret prefers not to be disclosed. Further, the apparatus of FIG. 1 may be vulnerable to attacks, which can be critical for e.g. critical infrastructure.

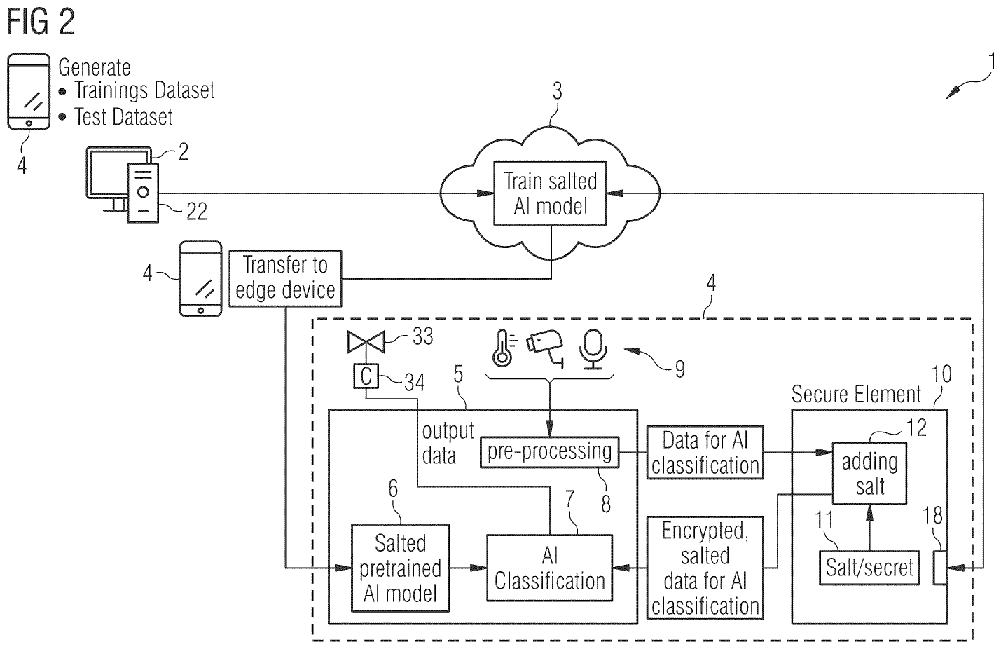

FIG. 2 discloses an embodiment of a training apparatus 1 with a protection for the AI model. The apparatus comprises a workstation 2 that is connected to the cloud 3 that contains hardware resources like servers to process training data. The workstation 2 is used to collect a training dataset 22, which may be collected by a couple of edge devices 4 with their respective sensors. The training dataset 22 helps with the generation of an AI model that classifies specific patterns in the datafile to classes. E.g. the training data set may comprise audio data and patterns with certain characteristics. The patterns may be classified as alternatively human voice, as dog barking or machine noise with the help of a neural network employing artificial intelligence. The training algorithm in the cloud 3 may comprise also data characterizing the hardware in the edge device 4 that eventually shall perform the classification in the field. The result of the training are parameters of the AI model which allow an edge device 4 to classify new audio data according to the classification used for the training.

The parameters of the AI model may differ with respect to the hardware configuration of the edge device 4 as in the embodiment of FIG. 1.

The edge device 4 of FIG. 2 comprises a microcontroller 5, one or more sensors 9 and a secure element 10. The microcontroller 5 comprises a memory 6, a pre-processor 8 and a classification stage 7. The secure element 10 contains a memory 11 for salt and a calculation stage 12. The secure element 10 further comprises an encryption unit 18 for encrypting the salt data before sending it to the cloud 3.

In contrast to FIG. 1, the dataset used to train the AI model gets salted before the training steps start. Salting means that the data is altered, wherein the altering may be performed e.g. by adding a fixed pattern, by exchanging frequency components or by running a more complex algorithm on the dataset. In practice, the test dataset contains a plurality of datasets, each generated by using a sensor of an edge device 4. The pattern or the algorithm used to salt the dataset is called salt. The salt is stored in the memory 11 of the secure element 10 being part of the edge device 4. In an embodiment, the salt is agreed on, with the help of the secure element 11, by the edge device and the cloud platform, like asymmetric cryptography, and sent during the training sequence to the cloud that performs the training. The salted dataset is generated by first altering the training data with the salt and then calculating the AI model. The parameters of the trained AI model are transferred to the edge device 4 and stored in the memory 6, which now contains the parameters of the salted pre-trained AI model, a model that can be used to classify new data that has undergone the same salting as the data test set during the training.

The generation of pre-trained AI models represents valuable intellectual property and often includes sensitive data. Therefore, securely storing the keys or the method to salt the generated data for AI classification with the specific pre-trained model is essential for system integrators. Therefore, hardware-based security would lower the attack vector, by serving security needs like generation of signatures based on RSA or elliptic curves or mutual authentication and encryption based on AES keys stored under tamper protection in the secure element. Customers look for reliable sub-systems with simple interfaces to be integrated into their application environment encapsulating all security critical operations, algorithms and data. The following crypto methods may be supported: DES, 3DES, AES 128, AES 256, RSA 1024 up to 4096, ECC 256 up to 521, ECDSA Signature, SHA-1 and SHA-256. Due to the availability of large NVM derivatives several 1000 of symmetric keys may be stored securely in the field for certain applications.

Secure elements for IoT security typically provide:
Secure hardware for performing public key cryptography operations;
Secure key storage;
Manufacturer-provided secret data programming (“secure provisioning”) for large-volume customers.

This cryptographic and key storage hardware have to meet high standards for security. Statements such as “EAL5+ certified” indicate that the hardware has been tested to be resistant against side channel attacks and other passive advanced attacks. They are also likely to have active hardware protection, such as “Active Shields”, against active physical attacks on the hardware, and have been tested against attacks such as fault injection and even as far as physical probing of the silicon die.

Hence, these devices may provide confidence that the public key cryptography and key storage are secure and reduce the risk of secret keys and private certificates being exposed. A manufacture-provided provisioning may be used. This means that the manufacturer of the microcontroller fills the secure element with data to be protected such that the customer that uses the microcontroller for producing his device does not need to put the secret in the secure element.

One may imagine a secure element as being a secure room containing a computer and storage that has very good physical security. All the information that is stored in the room can be considered to be safe from attackers and any computational operations that are performed on the computer in that room with the stored information is also safe from snooping. The secure provisioning is like the manufacturer having already put some information safely into the room even before the customer gets access to the room.

If the transfer of the parameters of the AI model from the cloud to an edge device 4 is accessed by an attacker, the attacker is prevented from using the AI model due the lack of the required salt. To protect access to the salt, the salt is stored within the secure element 11 and can only be accessed by password-protected secured communication from the outside. In a further embodiment, the communication related to the transfer of the parameters of the AI model from the cloud 3 to the edge device 4 is password-encrypted.

After the generation of the AI model, the parameters of the AI model will be transferred to the edge device 4 and stored in the memory 6 for the pre-trained AI model of the microcontroller 5. The microcontroller 5 may receive data from sensors 9 like a temperature sensor, a camera or a microphone. This data is fed to the pre-processor 8 of the microcontroller, which pre-processes the data, e.g. by AD-converting, filtering or error-correcting and forwards the pre-processed data to the secure element 10, in particular to the calculation stage 12. In another embodiment, the processor 5 retrieves the modifying data, the salt 11, from the secure element and applies the salt on the pre-processed data before pushing the data through the AI classification stage 7.

The calculation stage 12 is configured for modifying the pre-processed data based on the modifying data or salt and for outputting encrypted, modified or “salted” data. The classification stage 7 is configured for running the AI model on the encrypted, modified data and for outputting output data generated by running the AI model on the encrypted, modified data. In other words, the calculation stage 12 applies the salt and encrypts the data. The salted data is sent to the classification stage 7.

In order to pair the vendors specific pre-trained model in combination with the vendors edge device hardware, a secure element was introduced. The secure elements secret is merged with the training algorithm. Therefore, a data classification used by the dedicated vendors hardware is protected and only allowed in combination with the issued secure element.

In contrast to state-of-the art security measures, the edge device collected data can only be classified by the exact pre-trained model, if the collected data is going to be salted by the secure element. This prevents attackers from unauthorized copying of the AI model to other devices.

The salting algorithm may be any cryptographic algorithm that allows to manipulate data in a certain way, that features important for classifying are still existing, but the secret salt cannot be extracted from unsalted and salted data. This is for example the case with AES and the electronic-code-book mode.

This allows the binding but also protection from misuse of the edge device's hardware in combination with the pre-trained model. In cryptography, salt can be understood as a random or random-like data fed as an additional input to a one-way function that e.g. hashes data, or to a password or passphrase.

The classification stage 7 classifies the received sensor data that has been salted and outputs output data. The output data of the classification stage 7 may be used for an actuator 33, in this case a valve, of the edge device 4 or may be displayed to a user on a screen or may be forwarded to an instance external to the edge device 4.

The classification stage 7 is typically implemented in a microcontroller or microprocessor. It may contain a combination of software, hardware and firmware, running on a standard central processing unit. The classification stage 7 may search for characteristics in the data to classify frames of data into classes. The characteristics can be manifold, containing e.g. patterns of repetition, sudden shifts or frequency behaviors. As an AI model is used, characteristics that are typically not found by manually designed signal processing can make the distinction between classes.

Depending on the class, the edge device could activate an actuator like a valve in the embodiment of FIG. 2. A spoken word “open valve” could be interpreted in the edge device 4 by the classification, the output data of the classification stage will be transmitted to the controller 34 that opens the valve, e.g. in a heating system.

In other words, the edge device 4 comprises a first memory 6 configured to receive and store an artificial intelligence model (AI model) and a pre-processor 8 configured to pre-process sensor data. The edge device 4 further comprises a protected memory 11 for storing modifying data, which is also called salt data, and a classification stage 7 for running the AI model on the pre-processed salted data. The classification stage 7 outputs output data generated by running the AI model on the processing data and on the modifying data.

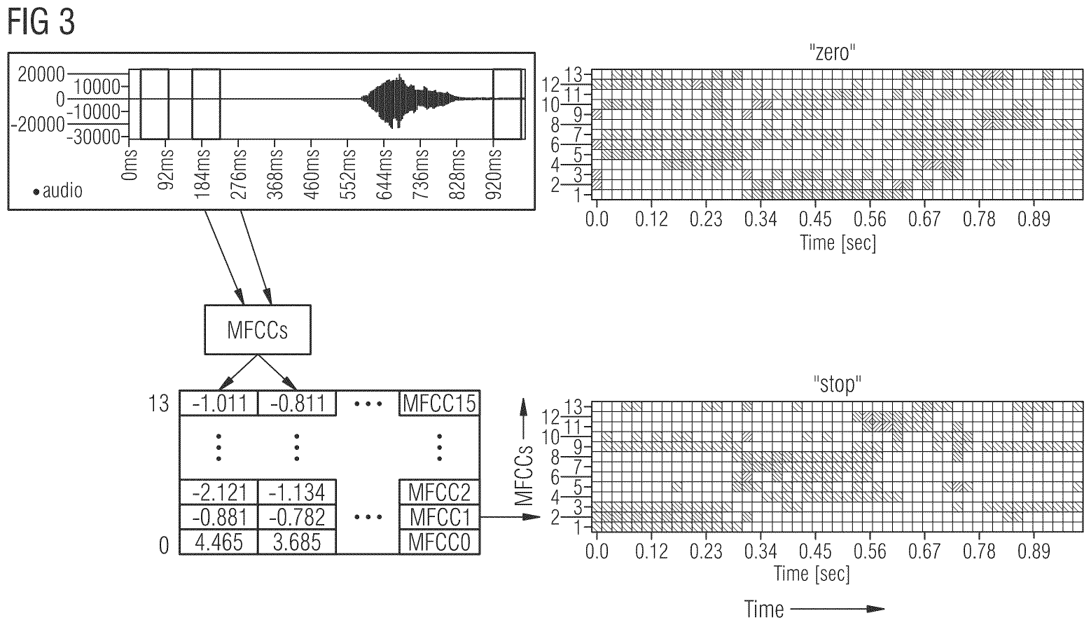

FIG. 3 demonstrates an embodiment in the area of voice recognition. A microphone receives audio signals. A sequence of an audio signal within a determined timeframe is converted to digital signals and then transformed using a linear cosine transform to a log power spectrum on a nonlinear mel scale of frequency. The resulting coefficients are Mel-frequency cepstral coefficients. This transform may be performed e.g. in the pre-processor 8 of FIG. 2.

Specifically, the upper left part of FIG. 3 shows an audio signal with the amplitude in the y-axis and the time in the x-axis. The time is divided into frames and each of the frames undergoes a MFCC transform. A typical MFCC transform is typically performed by a conversion to a frame, a discrete Fourier transform, taking the logarithm of the amplitude spectrum, Mel-scaling and smoothing and finally discrete cosine transform. An example of such transform of a voice recognition is plotted on the lower left side of FIG. 3 as a 14×16 array in FIG. 3. On the right side, visual representations of the MFCCs coefficients are displayed over time for two different voice signals. The values of the coefficients are color-coded to show the differences between an audio signal caused by the spoken word “stop” in comparison to the audio signal corresponding the spoken word “zero”.

Adding the “salt” can be done in many ways. In one embodiment, the MFCC values may be salted through encryption with electronic-code-book-mode methods, which use a specific codeword for a specific sequence of coefficient values. This provides a bijective coding such that the features of the array are still intact to be used for characterization. However, the method binds the classification to the secure element because it requires the encryption to work properly.

Furthermore, an additional static feature (e.g. a private key) can be used to overlay the array. This means, that a string of words is added to the MFCC coefficients. This allows a scrambling of the ML output and improves the security slightly.

An embodiment describes devices that classify audio input signals which can control the edge devices 4, e.g. via voice commands. During the training of the model, a secret “AI salt”, the modifying data, is added to the training data. The “AI salt” can contain simple measures like a frequency shift or an exchange of parameters or can involve more complex manipulation operations, which must be known by the training procedure as well as by the device itself.

In embodiments, a specific salt is stored in each device of a specific group of devices to bar third parties from using the same AI service. As an example, a light switch manufacturer may use the same salt for 100 000 devices. This salt may already be stored in the memory 11 during the production of the specific microcontrollers for these devices.

In the field, a user inputs his commands, e.g. voice commands, into the device, which senses the input. Then, the secret “AI salt” is added to the input data by either a trusted execution environment (TEE) on the microcontroller or this can be outsourced to a secure element which is protecting the “salt”. After being “salted”, the data is sent as input to the AI model, e.g. comprising a neural network, which is classifying the input to trigger specific subsequent actions.

An edge device 4 may be enhanced with a secure element 10 in order to ensure authenticity of the edge device 4 itself, for brand-protection or for simple protecting sensitive data. This may protect the AI model inherently and prevent misuse on altered or cloned devices.

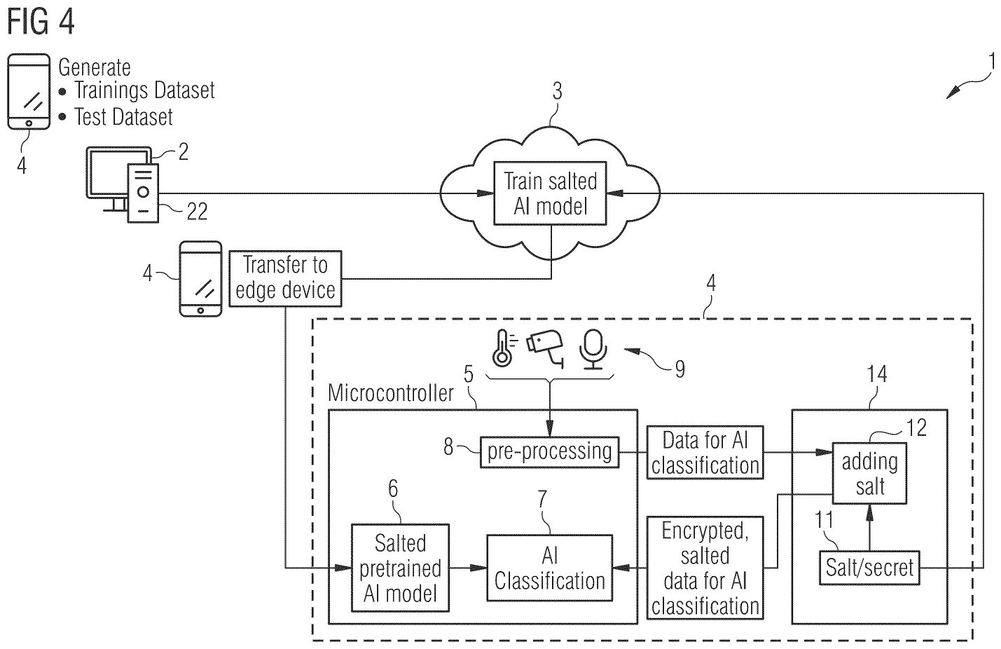

FIG. 4 shows an alternative embodiment, in which the modifying data, also called salt, is not stored in a secure element distant from the microcontroller 5, but in a protected memory within the microcontroller 5. The edge device 4 contains at least one sensor 9 and a microcontroller 5. The microcontroller 5 contains a pre-processor 8, an AI classification stage 7, a memory 6 for the AI model, also called first memory 6, and a trusted execution environment 14.

A trusted execution environment (TEE) is a secure area of a processor. The TEE helps to protect code and data loaded in the processor with respect to confidentiality and integrity. Data integrity prevents unauthorized entities from outside the TEE from altering data, while code integrity prevents code in the TEE from being replaced or modified by unauthorized entities, which may also be the computer owner himself.

In this embodiment, the TEE comprises a calculation stage 12 and a memory 11 for the salt.

The training of the AI model is performed as before, but the salt is transferred to the training cloud from the TEE 14 and not from a secure element 10.

The classification stage 7 classifies the received sensor data according to the pre-trained AI model in the memory 6.

In the field, the microcontroller 5 may receive data from a sensor 9. This data is fed to the pre-processor 8 of the microcontroller 5, which pre-processes the data, e.g. by AD-converting, filtering or error-correcting, and forwards pre-processed data to the TEE 14, in particular to the calculation stage 12. The calculation stage 12 is configured for modifying the pre-processed data based on the modifying data and for outputting encrypted, modified data. The classification stage 7 is configured for running the AI model on the encrypted, modified data and for outputting output data generated by running the AI model on the encrypted, modified data. The calculation stage 12 also receives the salt, adds the salt and thereby encrypts the data. The encrypted, salted data is sent to the AI classification stage 7. The classification stage 7 uses the salted pretrained AI model provided by the memory 6 to classify the pre-processed salted data.

The process of salting can be performed like in the embodiments above.

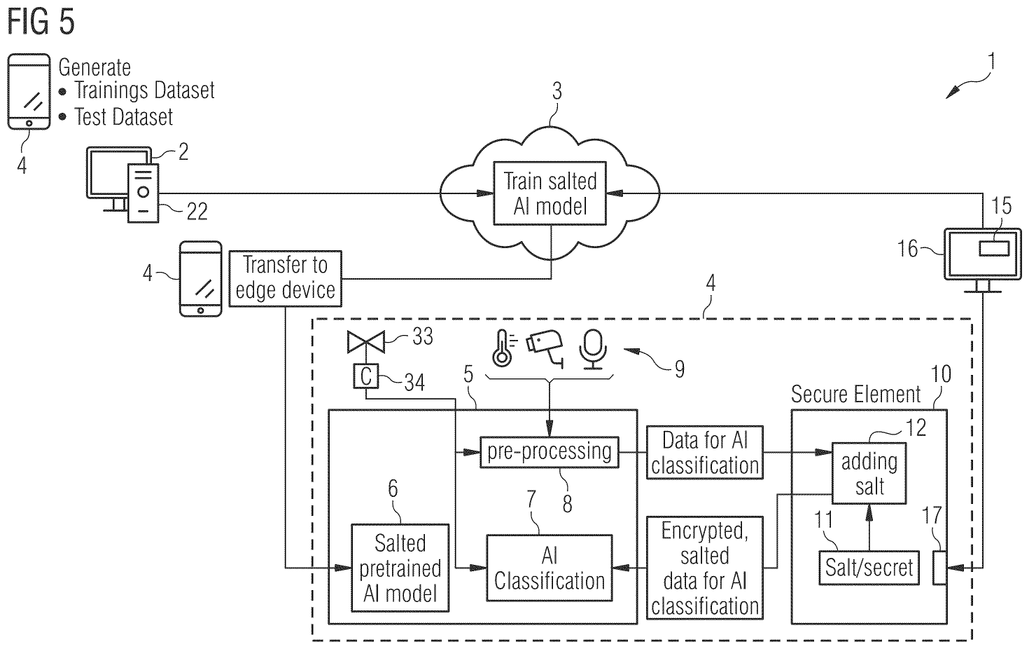

FIG. 5 shows an alternative embodiment for a training apparatus of an edge device 4. According to this embodiment, the salt is stored in a remote computer 16 which is accessible by the cloud 3 and by the edge device 4 through a communication network like the Internet. The remote computer 16 contains a memory 15 for the salt. If the remote computer 16 is accessed by the cloud 3 by encrypted communication it will provide the salt to the cloud 3, provided that the authentication of the cloud 3 with the remote computer 16 was successful. FIG. 5 shows that the salt provided by the remote computer 16 cannot be directly written into the memory 11 but only after being decrypted by the decryption unit 17.

Likewise, the remote computer 16 will send the data containing the salt to the edge device 4 after successful authentication. The edge device 4 will store the salt in the memory 11 of the edge device 4. In embodiments, the salt is stored once in the edge device 4 for its lifetime. In alternative embodiments, the salt is regularly updated in the remote computer 16 and the training and the storage of the salt in the edge device have to run again after each update.

The methods for protecting the AI model can be described as following. A method for classifying data at an edge device is provided. It comprises the steps of receiving configuration data for an artificial intelligence model (AI model), receiving sensor data from a sensor and receiving salt data from a protected memory element of the edge device, pre-processing the sensor data, running the AI model on the pre-processed data and on salt data and outputting output data generated by running the AI model on the processing data and the salt data.

In embodiments the protected memory 11 is part of a secure element 10 of the edge device 4, in others the protected memory 11 is part of a trusted execution environment (TEE) of a microprocessor 5.

A step for encrypting the salt data in response to a read request of the salt data by an external device may be provided. In examples, the salt contains an electronic-code-book coding.

The method may comprise a step of training the AI model based on test datasets and on the salt data and a step of transferring the trained AI model to the edge device 4.

The step of transferring may comprise encrypted communication.

In embodiments, the step of training comprises receiving salt data from a remote computer. Alternatively, the step of training comprises receiving salt data from the edge device 4.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

It should be noted that the methods and apparatus including its preferred embodiments as outlined in the present document may be used stand-alone or in combination with the other methods and apparatus disclosed in this document. In addition, the features outlined in the context of an apparatus are also applicable to a corresponding method, and vice versa. Furthermore, all aspects of the methods and apparatus outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiment outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

What is claimed is:

1. An edge device, comprising
a first memory configured to receive and store an artificial intelligence model (AI model);
a pre-processor configured to pre-process sensor data;
a protected memory configured for storing modifying data;
a calculation stage for modifying the pre-processed data based on the modifying data and for outputting encrypted, modified data; and
a classification stage configured for running the AI model on the encrypted, modified data and for outputting output data generated by running the AI model on the encrypted, modified data.

2. The edge device of claim 1, wherein the protected memory is part of a secure element of the edge device.

3. The edge device of claim 1, wherein the protected memory is part of a trusted execution environment (TEE) of a microprocessor.

4. The edge device of claim 1, further comprising
an encryption unit for encrypting the modifying data in response to a read request for the modifying data by an external device.

5. The edge device of claim 1, further comprising a sensor for providing the sensor data.

6. The edge device of claim 1, wherein the calculation stage implements an AES (Advanced Encryption Standard) encryption in electronic code-book mode.

7. A method for classifying data at an edge device, comprising:
receiving configuration data for an artificial intelligence model (AI model);
receiving sensor data from a sensor and receiving modifying data from a protected memory element of the edge device;
pre-processing the sensor data;
running the AI model on the pre-processed data and on the modifying data; and
outputting output data generated by running the AI model on the processing data and the modifying data.

8. The method of claim 7, wherein the protected memory is part of a secure element of the edge device.

9. The method of claim 7, wherein the protected memory is part of a trusted execution environment (TEE) of a microprocessor.

10. The method of claim 7, wherein the sensor data is encrypted based on the modifying data through AES (Advanced Encryption Standard) encryption in electronic-code-book mode.

11. The method of claim 7, further comprising
training the AI model based on test datasets and on the modifying data; and
transferring the trained AI model to the edge device.

12. The method of claim 11, wherein the transferring comprises encrypted communication.

13. The method of claim 11, wherein the training comprises receiving the modifying data from a remote computer.

14. The method of claim 11, wherein the training comprises receiving modifying data from the edge device.

15. An artificial intelligence (AI) based classification system for an edge device, comprising:
a memory configured to store a received AI model, wherein the AI model is pre-trained by an external device based on training data, wherein the training data comprises training edge device sensor data that is modified based on modifying data associated with the edge device;
a protected memory configured to store the modifying data;
a classification stage configured to run the AI model based on input data; and
a calculation stage configured to modify sensor data of the edge device based on the modifying data and provide the modified sensor data to the classification stage for use as input data for the AI model.

16. The AI based classification system of claim 15, further comprising an encryption unit configured to encrypt the modifying data prior to providing the modifying data to the external device.

17. The AI based classification system of claim 15, wherein the modifying data stored in the protected memory is received from a remote computer in an encrypted communication.

18. The AI based classification system of claim 15, further comprising a secure element configured to communicate with the external device to establish the modifying data associated with the edge device.

19. The AI based classification system of claim 15, wherein the protected memory is part of a secure element of the edge device.

20. The AI based classification system of claim 15, wherein the protected memory is part of a trusted execution environment (TEE) of a microprocessor.
